(19) United States
(12) Patent Application Publication
(10) Pub. No.: US 2013/0200964 A1
(43) Pub. Date: Aug. 8, 2013

(54) SECURITY SWITCH

(71) Applicant: Christopher Woods, Lee's Summit, MO (US)

(72) Inventor: Christopher Woods, Lee's Summit, MO (US)

(21) Appl. No.: 13/746,545

(22) Filed: Jan. 22, 2013

Related U.S. Application Data
(60) Provisional application No. 61/632,292, filed on Jan. 23, 2012.

(51) Int. Cl. H01H 36/00

(52) U.S. Cl. CPC H01H 36/0073
USPC 335/207; 335/205

(57) ABSTRACT

A security switch assembly is provided. The security switch assembly includes an electrically conductive housing having a cavity. The security switch assembly also includes a header assembly including a first and second contact pin, the header assembly coupled to the housing, wherein the first and second contact pin extend into the cavity of the housing. The security switch assembly further includes a moveable body moveably coupled within the cavity of the housing and between the first and second contact pin, wherein the moveable body rolls between a default position and an engaged position in response to altering the magnetic forces induced on the moveable body.

### CROSS REFERENCE TO RELATED APPLICATION

This application claims priority to U.S. Provisional Patent Application to Christopher Woods entitled “Security Switch,” Ser. No. 61/632,292, filed Jan. 23, 2012, now pending, the disclosure of which is hereby incorporated entirely herein by reference.

### BACKGROUND OF THE INVENTION

1. Technical Field

This invention relates generally to a security switch, and more particularly to an electrical security switch that is activated by magnetic forces.

2. State of the Art

The use of proximity switches is common with security systems. Conventional proximity switches are a type such that includes a magnetic body, electrical contacts and switch mechanism, such as a reed, that completes the circuit when a magnet is introduced in the proximity of the switch. Typically, the magnetic body moves in response to the introduction of a magnet, and the magnetic body engages a switch device that then connects the electrical contacts and completes the circuit. These switches are subject to easy damage and further failure if introduced to an outside magnetic field. This causes a limited life and unreliable switch to utilize in a security system.

### DISCLOSURE OF THE INVENTION

The present invention relates to a security switch that operated by magnetic forces applied to the security switch. Generally, a security switch according to embodiments includes a housing, conductive pins and a moveable body within the housing.

An embodiment includes a security switch assembly comprising an electrically conductive housing having a cavity; a header assembly including a first and second contact pin, the header assembly coupled to the housing, wherein the first and second contact pin extend into the cavity; and a moveable body moveably coupled within the cavity of the housing and between the first and second contact pin, wherein the moveable body rolls between a default position and an engaged position in response to altering the magnetic forces induced on the moveable body.

Another embodiment includes a security switch assembly comprising a housing having a cavity; a header assembly including a first pair of contact pins and a second pair of contact pins, the header assembly coupled to the housing, wherein the first and second pair contact pins extend into the cavity; and a moveable body moveably coupled within the cavity of the housing and between the first pair of contact pins and the second pair of contact pins, wherein the moveable body rolls between a default position and an engaged position in response to altering the magnetic forces induced on the moveable body.

Further, another embodiment includes a security switch assembly comprising an electrically conductive housing having a cavity; a header assembly including a first and second contact pin, the header assembly coupled to the housing, wherein the first and second contact pin extend into the cavity; a moveable body having a ball shape moveably coupled within the cavity of the housing and between the first and second contact pin, wherein the moveable body rolls between a default position and an engaged position; a biasing magnet adjacent the housing, the biasing magnet constantly inducing a magnetic force on the moveable body; and a drive magnet having a stronger magnetic force than the biasing magnet, the drive magnet moveable between a position proximate the housing and a position away from the housing. The biasing magnet moves the moveable body into the default position in response to moving the drive magnet away from the housing; and the drive magnet moves the moveable body into the engaged position in response to moving the drive magnet to the position proximate the housing.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures.

FIG. 1 is a side view of a security switch in accordance with an embodiment;

FIG. 2 is a top section view of the security switch of FIG. 1 taken along line A-A.

FIG. 3 is another side view of the security switch of FIG. 1 with a drive mechanism in proximity to the security switch.

FIG. 4 is a top section view of a security switch in accordance with another embodiment.

FIG. 5 is a section view of a prior art switch.

FIG. 6 is a section view of another prior art switch.

### DETAILED DESCRIPTION OF EMBODIMENTS OF THE INVENTION

As discussed above, embodiments of the present invention relate to a security switch that operated by magnetic forces applied to the security switch.

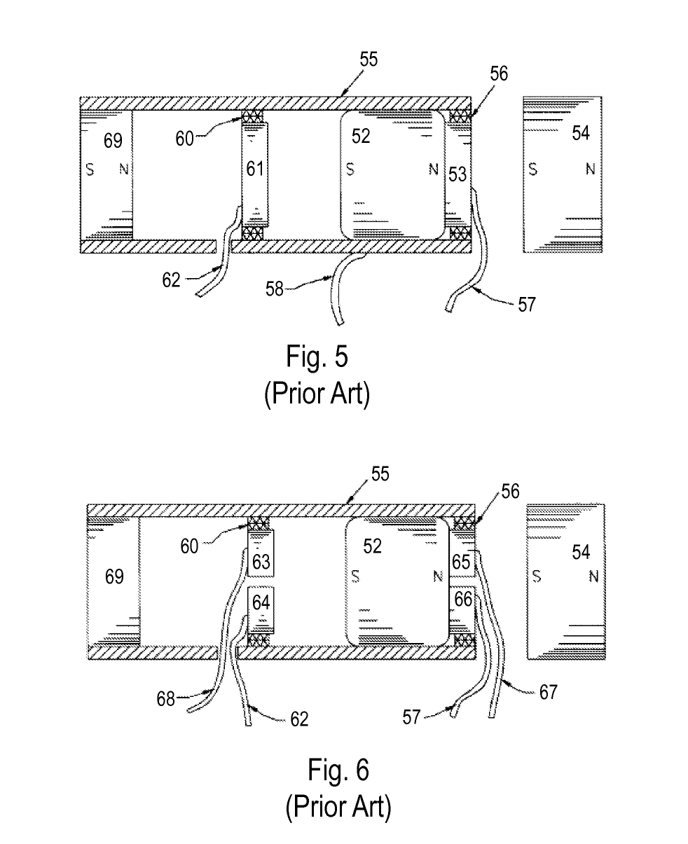

Conventional switches are depicted in FIGS. 5 and 6. As shown in FIG. 5, a switch has a conductive switch casing or tube 55, a spring magnet 69, made from any ferromagnetic material. The switch also includes an electrical contact 53 attached to an electrical insulator 56. Another electrical contact 61 is attached to an electrical insulator 60. An electrically conducting wire 57 is connected to the electrical contact 53, a second electrically conducting wire 58 is connected to the tube 55 and another electrically conducting wire 62 is connected to electrical contact 65. The switch includes a contact armature 52 made from any conducting permanent magnet material.

When the actuator magnet 54 is sufficiently removed from the proximity of the contact armature 52, the contact armature 52 is attracted to the spring magnet 69 and contacts the electrical contact 61 while maintaining contact with the tube 55. This results in a closed circuit state between the electrical conductor 61 and the tube 55 and an open circuit state between electrical conductor 53 and tube 55. The contact armature 52, when the actuator magnet 54 is sufficiently proximate to the contact armature 52, is more attracted to the actuator magnet 54 than the spring magnet 69 causing the contact armature 52 to travel toward and make electrical contact with the electrical contact 53 while maintaining contact with the tube 55, resulting in an open circuit state between the electrical conductor 61 and the tube 55 and a closed circuit state between electrical conductor 53 and tube 55.

In this prior art configuration, it should be understood that the contact armature 52 has a specific polarity and the size and shape of the tubing 55 constrains the armature 52 to always have the same fixed polarity. Accordingly, in order to the contact armature to move between each pair of electrical contacts, the spring magnet 69 and the actuator magnet 54 each have to be oriented properly in order to provide an attractive or a repulsive force. In other words, according to the prior art, the direct of the poles is a key factor in the operation of the switch.

As shown in FIG. 6, depicts a switch having a switch casing or tube 55 made of any non-magnetic material, a spring magnet 69, made from any ferromagnetic material. The switch also includes a pair of electrical contacts 65 and 66 are attached to an electrical insulator 56. Another pair of electrical contacts 63 and 64 is attached to an electrical insulator 60. An electrically conducting wire 57 is connected to the electrical contact 66, and another electrically conducting wire 67 is connected to the electrical contact 65. Further, an electrically conducting wire 62 is connected to the electrical contact 14, and another electrically conducting wire 68 is connected to the electrical contact 13. The switch includes a contact armature 52 made from any conducting permanent magnet material.

When the actuator magnet 54 is sufficiently removed from the proximity of the contact armature 52, the contact armature 52 is attracted to the spring magnet 69 and contacts the electrical contacts 63 and 64. This results in a closed circuit state between the electrical conductors 68 and 62 and an open circuit state between electrical conductors 57 and 67. The contact armature 52, when the actuator magnet 54 is sufficiently proximate to the contact armature 52, is more attracted to the actuator magnet 54 than the spring magnet 69 causing the contact armature 52 to travel toward and make electrical contact with the electrical contacts 65 and 66, resulting in an open circuit state between the electrical conductors 62 and 68 and a closed circuit state between electrical conductors 57 and 67.

In this prior art configuration, it should be understood that the contact armature 52 has a specific polarity and the size and shape of the tubing 55 constrains the armature 52 to always have the same fixed polarity. Accordingly, in order to the contact armature to move between each pair of electrical contacts, the spring magnet 69 and the actuator magnet 54 each have to be oriented properly in order to provide an attractive or a repulsive force. In other words, according to the prior art, the direct of the poles is a key factor in the operation of the switch.

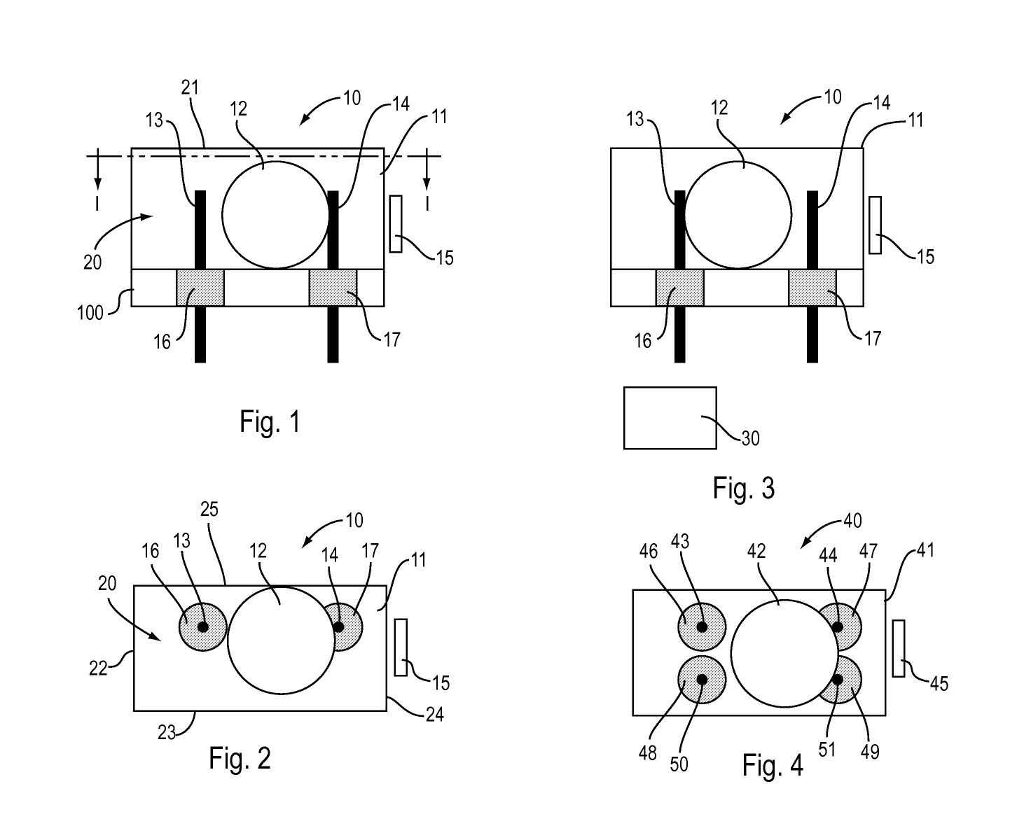

Embodiments of the present invention do not have the limitations of the prior art shown. Referring to the drawings, FIGS. 1-3 depict an embodiment of a security switch assembly 10. The switch assembly 10 comprises a conductive housing 11, wherein the conductive housing comprises a cavity 20. In particular embodiments, as shown in FIGS. 1-3, the cavity 20 may be defined between a top surface 21 and side surfaces 22, 23, 24, 25. For example, top surface 21, and side surfaces 22, 23, 24, 25 may form a box shape conductive housing 11 with an open end. At least in this way, the cavity 20 may be located as an inner volume of the box shape conductive housing 11. It will be understood that the conductive housing may be of any shape, so long as there is a cavity formed as an inner volume of the housing 11.

The switch assembly may further comprise a header assembly 100, wherein the header assembly 100 comprises a first electrically conductive contact pin 13 and a second electrically conductive contact pin 14. The first pin is mounted to the header assembly 100 through a first electrical insulator 16 and the second pin 14 is mounted to the header assembly 100 through a second electrical insulator 17. The header assembly 100 is coupled to the conductive housing 11, such that the first pin and second pin extend into the cavity 20 of the housing. Further, the switch assembly 10 further comprises a moveable body 12 moveably coupled within the cavity 20 of the housing 11 and the header assembly, wherein the moveable body 12 is located between the first pin 13 and the second pin 14. The moveable body 12 is formed of electrically conductive magnetically attractive material. In at least this way, the moveable body 12 is an electrically conductive magnetically attractive moveable body.

The switch assembly 10 may further comprise a biasing member 15, such as, but not limited to a biasing magnet or a biasing magnetically attractive material, wherein the biasing member 15 functions to move the moveable body 12 to a default position by magnetic forces. The moveable body 12 when in the default position is in contact with both the second pin 14 and a side surface of the housing 11. The moveable body 12 moves to the default position when another magnet is not within proximity, such as a drive magnet 30 (see FIG. 3), wherein the moveable body 12 has magnetic forces applied to it in order to move the moveable body 12.

According to embodiments, the moveable body 12 is a ball shape. Accordingly, the cavity 20 of the housing 11 is of a size and shape that allows for the moveable body 12 to freely roll and rotate. The rotation of the moveable body 12 or the rolling of the moveable body within the housing 11 ensures that the moveable body 12 will only move in response to a force that draws the moveable body 12 in a particular direction. In other words, according to embodiments, the moveable body 12 cannot be pushed by magnetic forces.

The switch assembly 10 may further comprise a drive member 30. The drive member 30 may be a drive magnet. The drive member 30 may be coupled to a moveable member, such as a door, wherein the drive member 30 is moveable between a position in close proximity to the housing 11 and a position a distance away from the housing 11. The distance away from the housing may be defined as a distance wherein the drive member 30 cannot induce a magnetic force on the moveable body 12. The magnetic force introduced onto the moveable body 12 when the drive member 30 is in close proximity to the housing 11 is stronger than the magnetic force applied to the moveable body 12 by the biasing member 15. In this embodiment, the drive member 30 induces a magnetic force that is strong enough to move the moveable body 12 from a default position to an engaged position. The moveable body 12 is in the engaged position when it is in contact with the first pin 13 and the housing 11.

According to the embodiment shown in FIGS. 1-3, the moveable body 12 may be an electrically conductive magnetically attractive moveable body, the biasing member 15 may be a magnet and the drive member 30 may be a drive magnet. The shape of the moveable body 12 may be a ball and is of a size and shape as to be able to rotate at least 180 degrees within the housing 11. The biasing magnet 15 moves the moveable body 12 by rolling it into the default position in contact with the second pin and the housing 11 due to the magnetic force placed upon the moveable body by the biasing magnet 15 as the drive magnet 30 is moved from close proximity to a distance away from the housing 11. As the drive magnet 30 is moved back to close proximity of the housing 11, the magnetic force applied to the moveable body 12 by the drive magnet 30 is strong enough to overcome the magnetic attractive force of the biasing magnet 15. The moveable body 12 then rolls into the engaged position in contact with the first pin 13 and the housing 11. Further, the switch 10 may be electrically coupled to an alarm system, wherein one circuit is closed from the switch 10. Accordingly, embodiments may include a circuit that is closed when the moveable body 12 is in the engaged position and contacting the first pin 13 and the housing 11, thereby leaving the default position with the moveable body 12 in contact with the second pin 14 and the housing 11 to be an opened circuit. Conversely, other embodiments may include a circuit that is opened when the moveable body 12 is in the engaged position and contacting the first pin 13 and the housing 11, thereby leaving the default position with the moveable body 12 in contact with the second pin 14 and the housing 11 to be a closed circuit. In each case, the alarm system processes the signal produced by the switch in order to alert unauthorized entry through an opening that the switch 10 is coupled to.

According to embodiments, the moveable body 12 is not confined to cause one polarity to be maintained in a first direction along some fixed axis, but rather, the moveable body 12 is free to rotate, so that the moveable body 12 is always attracted to the drive magnet 30 regardless of the polarity of the drive magnet 30 as it approaches the switch 10, and further is always attracted to the biasing member when the drive magnet 30 is moved away from the switch 10.

Accordingly, as magnetic forces are applied to the moveable body 12, the ball rotates depending on the location of the pole that is attracted to the magnetic force being applied. In other words, if a pole of the biasing magnet 15 has a south pole closest to the housing, the moveable body 12 would rotate until the north pole of the moveable body was attracted to the south pole. Likewise, if it was a north pole closest to the housing. The drive magnet 30, may also have any pole in proximity to the housing 11 and the moveable body 12 would rotate based on the polarity and be drawn to the drive magnet 30. In this way, the moveable body 12 is always moving in a direction of attraction and not in repulsion.

These embodiments are improvements over prior art, wherein the prior art describes a moveable body that is in a fixed orientation within and enclosure, wherein the pole direction is critical to the operation because the moveable body can only be attracted or repulsed in one direction based on the polarity of the magnet that is introduced to the moveable body. Embodiments of this disclosure depict and describe a moveable body 12 that does not require a fixed polarity orientation of the moveable body 12, the biasing member 15 or the drive member 30.

Referring to the drawings again, FIG. 4 depicts another embodiment of a security switch assembly 40. The switch assembly 40 comprises a housing 41, wherein the housing comprises a cavity 60. In particular embodiments, as shown in FIG. 4, the cavity 60 may be defined between a top surface and side surfaces as described with regard to cavity 20 in FIGS. 1-3. At least in this way, the cavity 60 may be located as an inner volume of the box shape conductive housing 41. It will be understood that the housing 40 may be of any shape, so long as there is a cavity formed as an inner volume of the housing 41.

The switch assembly may further comprise a header assembly 200, wherein the header assembly 200 comprises a first electrically conductive contact pin 43, a second electrically conductive contact pin 44, a third electrically conductive contact pin 50 and a fourth electrically conductive contact pin 51. The first pin 43 is mounted to the header assembly 200 through a first electrical insulator 46; the second pin 44 is mounted to the header assembly 200 through a second electrical insulator 47; third pin 50 is mounted to the header assembly 200 through a third electrical insulator 48; and the fourth pin 51 is mounted to the header assembly 200 through a fourth electrical insulator 49. The header assembly 200 is coupled to the conductive housing 41, such that the contact pins 43, 44, 50, 51 extend into the cavity 60 of the housing. Further, the switch assembly 40 further comprises a moveable body 42 moveably coupled within the cavity 60 of the housing 41 and the header assembly, wherein the moveable body 42 is located between a first pair of contact pins comprising the first pin 43 and third pin 50 on one side and a second pair of contact pins comprising the second pin 44 and fourth pin 51 on the other side. The moveable body 42 is formed of electrically conductive magnetically attractive material. In at least this way, the moveable body 42 is an electrically conductive magnetically attractive moveable body.

The switch assembly 40 may further comprise a biasing member 45, such as, but not limited to a biasing magnet or a biasing magnetically attractive material, wherein the biasing member 45 functions to move the moveable body 42 to a default position by magnetic forces. The moveable body 42 when in the default position is in contact with both the second and fourth pin 44, 51. The moveable body 42 moves to the default position when another magnet is not within proximity, such as a drive magnet 30 (see FIG. 3), wherein the moveable body 42 has magnetic forces applied to it in order to move the moveable body 42.

According to embodiments, the moveable body 42 is a ball shape. Accordingly, the cavity 60 of the housing 41 is of a size and shape that allows for the moveable body 42 to freely roll and rotate. The rotation of the moveable body 42 or the rolling of the moveable body within the housing 41 ensures that the moveable body 42 will only move in response to a force that draws the moveable body 42 in a particular direction. In other words, according to embodiments, the moveable body 42 cannot be pushed by magnetic forces.

The switch assembly 40 may further comprise a drive member 30. The drive member 30 may be a drive magnet. The drive member 30 may be coupled to a moveable member, such as a door, wherein the drive member 30 is moveable between a position in close proximity to the housing 41 and a position a distance away from the housing 41. The distance away from the housing may be defined as a distance wherein the drive member 30 cannot induce a magnetic force on the moveable body 42. The magnetic force introduced onto the moveable body 42 when the drive member 30 is in close proximity to the housing 41 is stronger than the magnetic force put on the moveable body 42 by the biasing member. In this embodiment, the drive member 30 induces a magnetic force that is strong enough to move the moveable body 42 from a default position to an engaged position. The moveable body 42 is in the engaged position when it is in contact with the first pin 43 and the third pin 50. Accordingly, embodiments may include a circuit that is closed when the moveable body 42 is in the engaged position and contacting the first and third pins 43 and 50, thereby leaving the default position with the moveable body 42 in contact with the second and fourth pins 44 and 51 to be an opened circuit. Conversely, other embodiments may include a circuit that is opened when the moveable body 42 is in the engaged position and contacting the first and third pins 43 and 50, thereby leaving the default position with the moveable body 42 in contact with the second and fourth pins 44 and 51 to be a closed circuit. In each case, the alarm system processes the signal produced by the switch in order to alert unauthorized entry through an opening that the switch 40 is coupled to.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A security switch assembly comprising:
an electrically conductive housing having a cavity;
a header assembly including a first and second contact pin, the header assembly coupled to the housing, wherein the first and second contact pin extend into the cavity; and
a moveable body moveably coupled within the cavity of the housing and between the first and second contact pin, wherein the moveable body rolls between a default position and an engaged position in response to altering the magnetic forces induced on the moveable body.

2. The assembly of claim 1, wherein the engaged position comprises the moveable body in contact with the first contact pin and the conductive housing.

3. The assembly of claim 1, wherein the default position comprises the moveable body in contact with the second contact pin and the conductive housing.

4. The assembly of claim 1, further comprising a biasing member, wherein the biasing member constantly induces a magnetic force on the moveable body and moves the moveable body into the default position in the absence of other magnetic forces.

5. The assembly of claim 4, further comprising a drive magnet having a magnetic force stronger than the biasing member, wherein the drive magnet moves the moveable body into the engaged position in response to moving the drive magnet in close proximity to the conductive housing.

6. The assembly of claim 5, wherein the moveable body is moved between the default and engaged positions by magnetic attractive forces.

7. The assembly of claim 6, wherein the moveable body moves by magnetic forces regardless of the polarity of the drive magnet and the biasing member.

8. A security switch assembly comprising:
a housing having a cavity;
a header assembly including a first pair of contact pins and a second pair of contact pins, the header assembly coupled to the housing, wherein the first and second pair contact pins extend into the cavity; and
a moveable body moveably coupled within the cavity of the housing and between the first pair of contact pins and the second pair of contact pins, wherein the moveable body rolls between a default position and an engaged position in response to altering the magnetic forces induced on the moveable body.

9. The assembly of claim 8, wherein the engaged position comprises the moveable body in contact with the first pair of contact pins.

10. The assembly of claim 8, wherein the default position comprises the moveable body in contact with the second pair contact pins.

11. The assembly of claim 8, further comprising a biasing member, wherein the biasing member constantly induces a magnetic force on the moveable body and moves the moveable body into the default position in the absence of other magnetic forces.

12. The assembly of claim 11, further comprising a drive magnet having a magnetic force stronger than the biasing member, wherein the drive magnet moves the moveable body into the engaged position in response to moving the drive magnet in close proximity to the conductive housing.

13. The assembly of claim 12, wherein the moveable body is moved between the default and engaged positions only by magnetic attractive forces.

14. The assembly of claim 13, wherein the moveable body moves by magnetic forces regardless of the polarity of the drive magnet and the biasing member.

15. A security switch assembly comprising:
an electrically conductive housing having a cavity;
a header assembly including a first and second contact pin, the header assembly coupled to the housing, wherein the first and second contact pin extend into the cavity;
a moveable body having a ball shape moveably coupled within the cavity of the housing and between the first and second contact pin, wherein the moveable body rolls between a default position and an engaged position;
a biasing magnet adjacent the housing, the biasing magnet constantly inducing a magnetic force on the moveable body; and
a drive magnet having a stronger magnetic force than the biasing magnet, the drive magnet moveable between a position proximate the housing and a position away from the housing, wherein:
the biasing magnet moves the moveable body into the default position in response to moving the drive magnet away from the housing; and
the drive magnet moves the moveable body into the engaged position in response to moving the drive magnet to the position proximate the housing.

16. The assembly of claim 15, wherein the engaged position comprises the moveable body in contact with the first contact pin and the conductive housing.

17. The assembly of claim 15, wherein the default position comprises the moveable body in contact with the second contact pin and the conductive housing.

18. The assembly of claim 17, wherein the moveable body is moved between the default and engaged positions only by magnetic attractive forces.

19. The assembly of claim 18, wherein the moveable body moves by magnetic forces regardless of the polarity of the drive magnet and the biasing member.

20. The assembly of claim 15, further comprising a security system, wherein one of the first or second contact pins is electrically connected to the security system and forms a closed circuit when the moveable body is in contact with one of the first or second contact pin that is electrically connected to the security system.
